(19) United States
(12) Patent Application Publication
(10) Pub. No.: US 2007/0160256 A1
(43) Pub. Date: Jul. 12, 2007

(54) Coaxial two-way drive unit for horn speakers

(75) Inventors: Alessandro Genovese, Pisa (IT); Roberto Coppini, Florence (IT)

Correspondence Address: POLLACK, P.C., THE CHRYSLER BUILDING, 132 EAST 43RD STREET, SUITE 760, NEW YORK, NY, 10017, US

(73) Assignee: B & C Speakers S.p.A.

(21) Appl. No.: 11/487,754

(22) Filed: Jul. 15, 2006

(30) Foreign Application Priority Data
Jul. 15, 2005 (IT) FI2005A000155

(51) Int. Cl. H04R 9/06

(52) U.S. Cl. 381/401

(57) ABSTRACT

A two-way drive unit for horn-loading speakers, comprising a fist voice coil drive unit associated with a second voice coil drive unit. The first unit is a frustum of a cone shape, whereas the second unit is shaped like an annular diaphragm with a voice coil arranged on a circle between the inner and outer circular perimeter of the annular diaphragm. The first drive unit is associated with a truncated, segmented, substantially conical element, with a first end facing towards the cone and a second tapered end facing the mouth of the drive unit, the second drive unit being associated with an ogive-shaped element cooperating with the substantially conical elements and facing the mouth of the drive unit. The first and second drive units are associated with a respective magnetic structure with a relatively high-energy permanent magnet that defines first and second air gaps cooperating with the voice coil of the cone-shaped element and with the voice coil of the annular diaphragm-shaped element.

### FIELD OF THE INVENTION

The present invention relates generally to sound production apparatus and, more particularly, to horn-type speakers and the like.

### BACKGROUND OF THE INVENTION

Conventional mechanical horn-type speakers have long been recognized for workable sound reproduction. With the advent of power electronics and fueled by a desire for improvements in sound reproduction quality, technology then advanced to electrodynamic speakers of the cone and voice coil type. While the improvements in sound reproduction quality achieved were considerable, the acoustic power that could be radiated (i.e., sound effects and/or voice reproduction) was limited ultimately to the size of the speaker cone. More specifically, as the cone increases in size, the greater its inertia, and, in turn, the more undesireable resonance that results. While the sound quality achieved by these arrangements was considered useful, they were often unacceptable for applications where a full range of high quality sound reproduction was desired.

Then horn speakers were developed with a control unit formed from a membrane associated with a voice coil, arranged in the throat of the horn. This type of speaker was hugely popular especially in open areas for projecting speeches to the greater public in demonstrations especially before and after the Second World War. This type of speaker does not lend itself very well to the reproduction of music given the wide range of frequencies that are used in music, especially “modern music”. During the pre- and post-Second World War period these horn speakers, be they “direct” or folded in various ways, were limited to the reproduction of “speech” in the frequency range of about 300-3000 Hz. A range of this type is totally unsuitable for music.

Many efforts have been made to improve the power and frequency efficiency of this type of speaker. See for example U.S. Pat. No. 1,715,703 to C. R. Hanna issued on 4 Jun. 1929, and U.S. Pat. No. 2,037,187 to E. C. Wente issued on 14 Apr. 1936.

In the last few decades there has been a need for electroacoustic systems capable of satisfying requirements of musical fidelity and power irradiated: consider concerts that can have tens of thousands of people, and the individual listener's desire for extremely high acoustic intensities that can even reach the so-called “pain threshold” limits.

Persons skilled in the art have recognized that an audio frequency range suitable for modern music cannot be reproduced by a single transducer (speaker) and groups of speakers have been developed each of which reproduces a certain range of frequencies, known in the field as “subwoofer, woofer, mid-range, tweeter” and the like.

### OBJECTS AND SUMMARY OF THE INVENTION

Accordingly, it is an object of the present invention to provide a coaxial two-way drive unit for horn-loading.

According to the present invention a two-way drive unit for horn-loading speakers is foreseen, comprising a first voice coil drive unit associated with a second voice coil drive unit; said first unit being frustum of cone shaped; said second unit being in the shape of an annular diaphragm with the voice coil arranged on a circle placed between the inner and outer circular perimeter of the annular diaphragm; the first drive unit being associated with a truncated segmented substantially conical element, with a first end facing towards the cone and a second tapered end facing towards the mouth of the drive unit; the second drive unit being associated with a substantially ogive-shaped element cooperating with said conical element and facing towards the mouth of the drive unit; the first and second drive unit being associated with a respective magnetic structure preferably having a permanent magnet that defines a first and a second air gap cooperating with the voice coil of the cone-shaped element and with the voice coil of the annular diaphragm shaped element.

### BRIEF DESCRIPTION OF THE DRAWINGS

A specific, illustrative coaxial two-way drive unit, according to the present invention, is described below with reference to the accompanying drawings, in which:

FIG. 1 is a partial sectional view of a coaxial two-way drive unit, according to one aspect of the present invention;

FIG. 2 is an enlarged partial sectional view of the part of the drive unit set forth in FIG. 1 that highlights the annular diaphragm and relative horn structure;

FIG. 3 is another enlarged partial sectional view of the annular radiator shown in FIGS. 1 and 2 above;

FIG. 4 is an exploded perspective view of the drive unit components illustrated in FIGS. 1-3 above;

FIG. 5 is a partial sectional view of a coaxial two-way drive unit, according to another aspect of the present invention;

FIG. 6 is a partial sectional view of a coaxial two-way drive unit, in accordance with a further aspect of the present invention; and

FIG. 7 is an exploded perspective view of the drive unit components illustrated in FIG. 6.

Still other objects and advantages of the present invention will become apparent from the following description of the preferred embodiments.

### DETAILED DESCRIPTION OF THE PREFERRED EMBODIMENTS

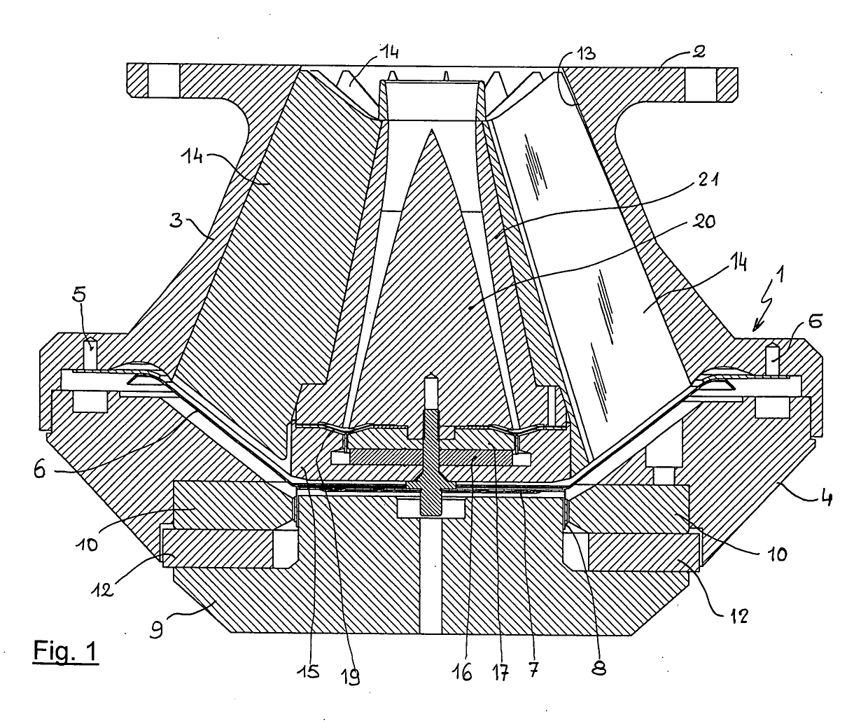

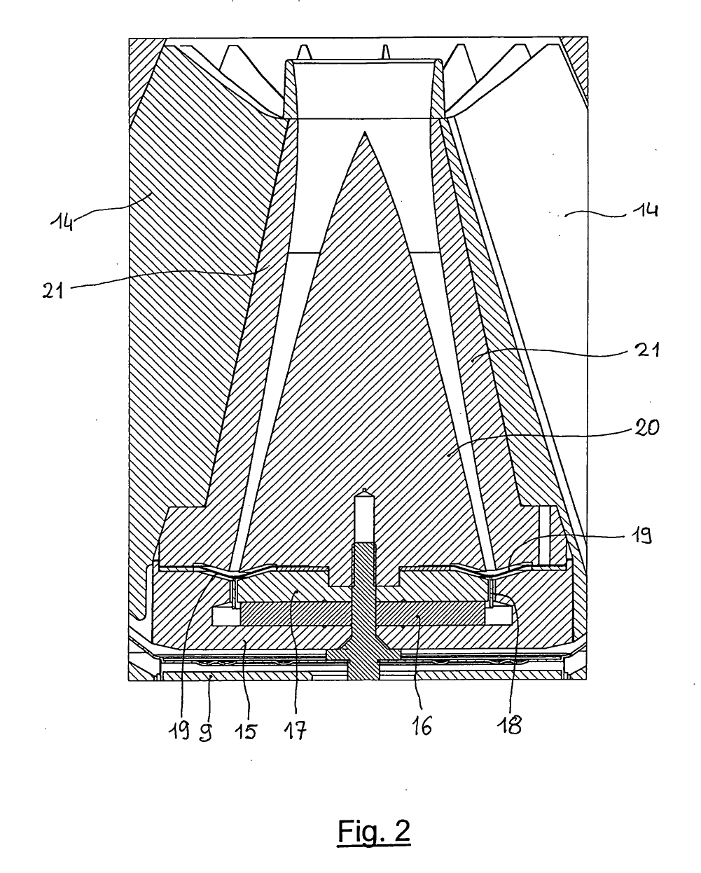

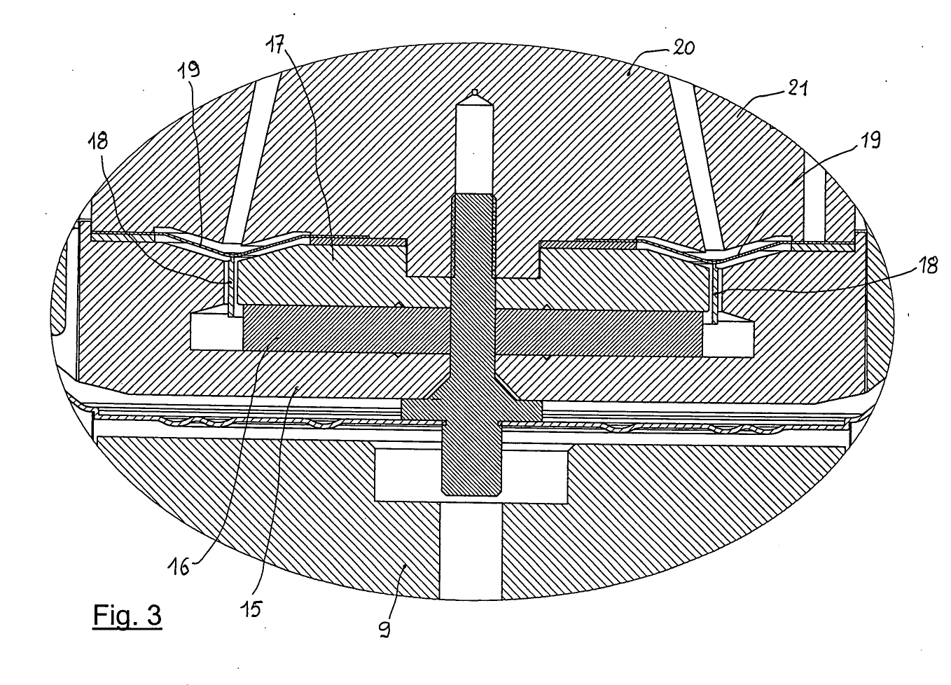

Referring now to the drawings and, more particularly, to FIGS. 1-7, there is shown generally a specific, illustrative coaxial two-way drive unit for horn speakers, according to various aspects of the present invention. In one embodiment, illustrated in FIG. 1, the drive unit comprises a body 1 having a flange 2 for mechanical coupling with a horn structure of the conventional type.

A body 1 comprises a first part 3 and a second base part 4 joined together through screws 5. The rim of a speaker cone 6, which can be made from various materials, is locked between the part 3 and the part 4 and is associated with a spider 7. In the joining point between the cone 6 and the spider 7 a cylindrical voice coil 8 is arranged that is axially mobile in an air gap formed from a block 9 and from the annular pole piece 10 that together define an air gap. In the air gap there is a magnetic field preferably produced by a magnet 12, which can be of the high-energy type (for example one or more magnets of the neodymium, samarium-cobalt and similar types introduced into technology relatively recently).

It is clear to a person skilled in the art that the cone 6 is not necessarily a cone of Euclidean geometry, but that it could take up configurations that deviate from that of a pure geometrical cone as is well known in the field of speakers and of excitation membranes of drive units for horn speakers.

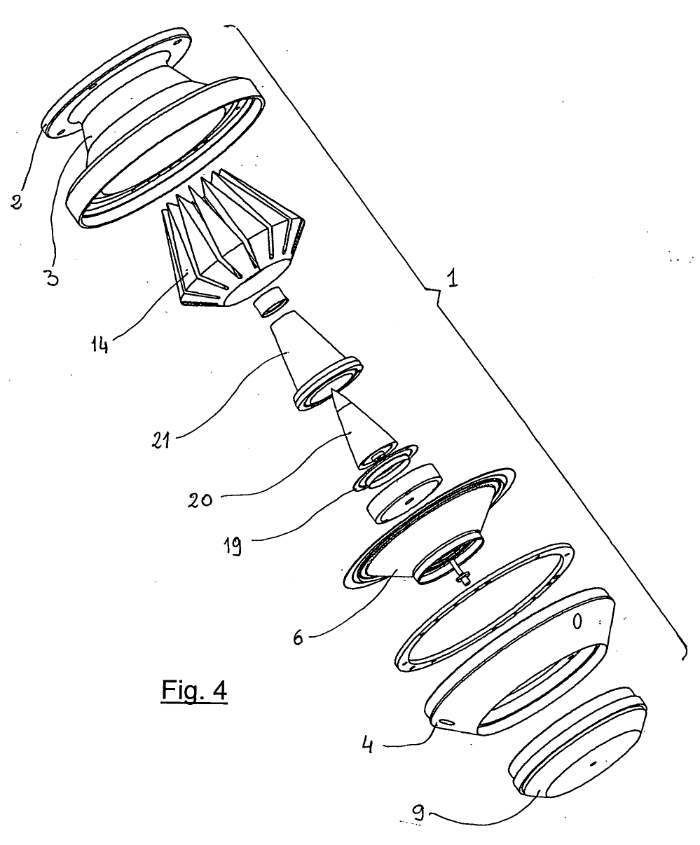

The body 3 is internally configured with a hollow frustum of cone shape 13, in which a star-shaped structure is contained comprising a multiplicity of tabs 14 (as can be seen more clearly in FIG. 4) to form a group of tubular ducts to convey the acoustic energy produced by the cone 6 towards the mouth of the flange 2.

This structure allows pressure (and rarefaction) waves to be obtained having a uniform front on the mouth of the flange 2 in order to avoid disuniformity in acoustic response according to the control frequencies of the voice coil 8 in the operative range of the cone 6.

In the housing formed from the inner part of the structure with tabs 14 the second drive unit for high frequencies is arranged situated above the spider 7 and comprising a block of ferromagnetic material 15 that cooperates with a high-energy disc magnet 16 and a ferromagnetic element 17 to form an annular air gap in which a voice coil 18 of an annular diaphragm 19 can move. The annular diaphragm 19 is intended to reproduce the high frequencies of sounds that must be irradiated from the horn speaker.

The annular diaphragm 19 can be made with a plastic material like for example mylar, although this does not mean that other materials cannot also be used, as is clear to a person skilled in the art.

The annular diaphragm 19 cooperates with a structure substantially for guiding sound waves formed from the spacing between an ogive-shaped element 20 and a hollow conical element 21 arranged inside the structure with tabs 14.

The spacing between the ogive 20 and the element 21 substantially constitutes a revolution sound wave guide that opens out towards the end of the tabs 14 near to the mouth of the control unit 1.

The frequency responses of the secondary radiator and of the primary radiator are selected with the dimensioning of the mechanical parts, of the rigidity of the cone and of the annular diaphragm to obtain a uniform overall response in the field of frequencies in question. The voice coils of the cone and of the annular diaphragm can possibly be controlled through usual power level crossover and/or signal filters as is known in electroacoustics.

As a non-limiting example, the following data relating to a construction according to the present invention is shown:

| | |
|---|---|
| Cone diameter: | mm 110 |
| Voice coil diameter: | mm 50 |
| Material of the cone: | composite material |
| annular radiator | |
| outer diameter: | mm 40 |
| inner diameter: | mm 25 |
| material: | plastic |
| Magnetic flux density in the | 2.1 T |
| air gap of the cone: | |
| Magnetic flux density in the | 1.2 T |
| air gap of the annular | |
| radiator: | |
| Response in frequency of the | 300-10000 Hz |
| cone: | |
| Response in frequency of the | 8000-20000 Hz |
| annular radiator: | |
| Deviation from linearity of | +/−02 dB |
| response in frequency: | |

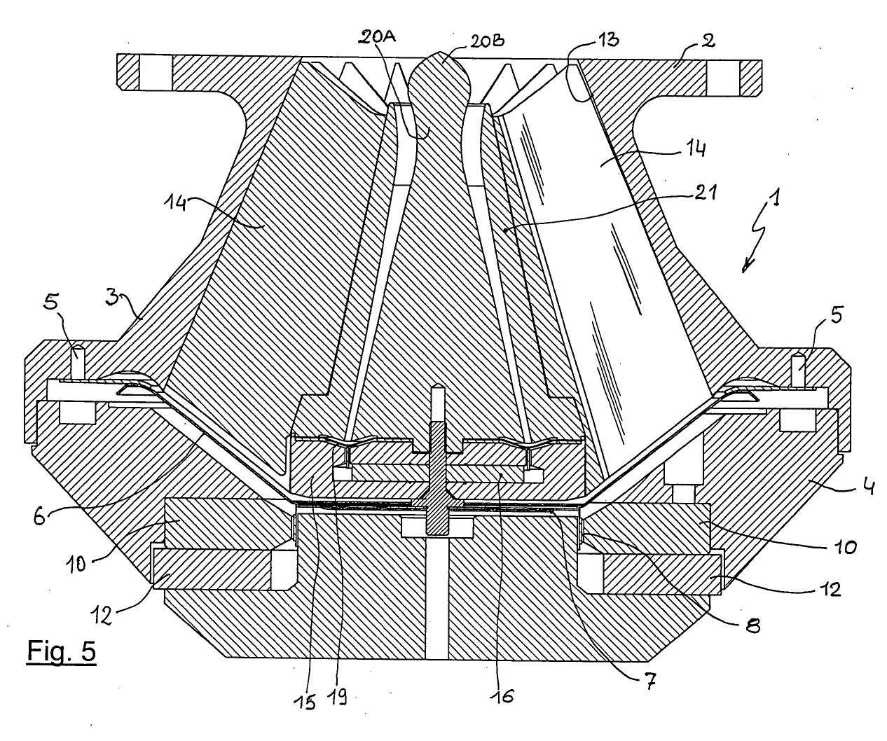

With reference to FIG. 5, a first variant of the structure illustrated in reference to FIGS. 1 to 4 shall now be described.

As can be seen from FIG. 5, the ogive-shaped element 20 is formed from a substantially conical-shaped structure 20a that at 20B terminates, instead of in a point in a tear drop shape, and moreover the element 21 is shortened with respect to the corresponding element 21 shown in FIG. 1.

The rest of the construction shown in FIG. 5 is identical to the one shown in the previous figures and therefore we shall not make a detailed description thereof.

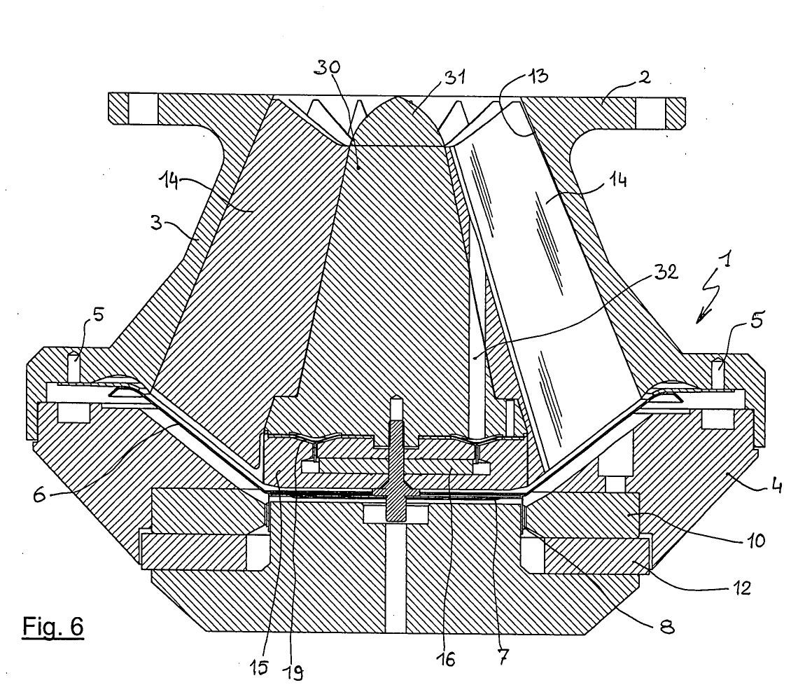

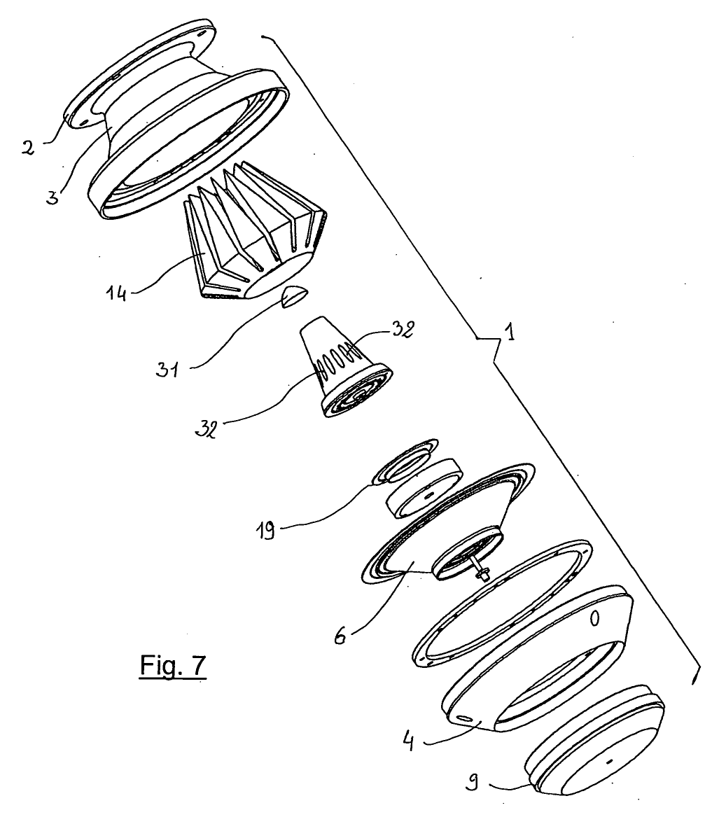

Now with reference to FIGS. 6 and 7, a further modification of the construction according to the present invention shall be illustrated.

As can be seen in FIGS. 6 and 7, a conical element 30 is provided with the base at the annular diaphragm 19, and that mechanically couples in a restricted manner with the element 14, and that terminates in an ogive 31.

As can be seen in FIG. 6 and 7, the conical element 30 is equipped with a multiplicity of holes 32 arranged circumferentially and substantially centred at the circumference described by the mobile voice coil of the annular diaphragm 19.

The holes 32 lead the pressure and rarefaction waves produced by the diaphragm 19 towards the mouth of the drive unit defined in the flange 2.

In a further variant that is not shown, the holes 32 instead of being cylindrical are cone-shaped, with the tip of the ideal cone facing towards the annular diaphragm 19 and the base towards the element 14 and therefore the mouth of the drive unit.

Various modifications and alterations may be appreciated based on a review of this disclosure. These changes and additions are intended to be within the scope and spirit of the invention as defined by the following claims.

What is claimed is:

1. A two-way drive unit for horn-loading speakers, comprising a first voice coil drive unit associated with a second voice coil drive unit, the first unit being a frustum of a cone shape, and the second unit being shaped like an annular diaphragm with a voice coil arranged on a circle between the inner and outer circular perimeter of the annular diaphragm, the first drive unit being associated with a truncated, segmented, substantially conical element, with a first end facing generally the cone and a second tapered end facing generally a mouth of the drive unit, the second drive unit being associated with an ogive-shaped element cooperating with the substantially conical element and facing generally the mouth of the drive unit, the first and second drive unit being associated with a respective magnetic structure with a relatively high-energy permanent magnet that defines first and second air gaps cooperating with the voice coil of the cone-shaped element with the voice coil of the annular diaphragm-shaped element.

2. The drive unit set forth in claim 1, wherein the segmented conical element comprises a plurality of tabs arranged circumferentially.

3. The drive unit set forth in claim 1, wherein the segmented conical element has a part with a generally greater diameter facing generally the cone and a part with a relatively smaller diameter facing generally an outlet mouth of the drive unit.

4. The drive unit set forth in claim 1, wherein the ogive-shaped element has a tapered tip facing generally the mouth of the drive unit.

5. The drive unit set forth in claim 1, wherein the ogive-shaped element has a substantially tear drop configuration arranged at the mouth of the drive unit.

6. The drive unit set forth in claim 1, wherein the ogive-shaped element is equipped with a multiplicity of holes arranged circumferentially substantially at the annular diaphragm.

7. The drive unit set forth in claim 6, wherein the holes are cylindrical.

8. The drive unit set forth in claim 6, wherein the holes are conical with the “apex” facing toward the annular diaphragm and the “base” facing toward the mouth.

9. The drive unit set forth in claim 2, wherein the ogive-shaped element and the substantially conical element with tabs define a substantially annular wave guide that begins at the annular diaphragm and opens out toward the mouth.

10. The drive unit set forth in claim 1, wherein the cone-shaped element is constructed of one or more polymeric material(s), metal(s), composite(s), and/or the like.

11. The drive unit set forth in claim 1, wherein the annular diaphragm is constructed of one or more polymeric material(s), metal(s), composite(s), and/or the like.
